(19) United States
(12) Patent Application Publication
(10) Pub. No.: US 2021/0328638 A1
(43) Pub. Date: Oct. 21, 2021

(54) Smart Geospatial Antenna

(71) Applicant: Adcor MAGnet Systems, LLC, Baltimore, MD (US)

(72) Inventors: Evangelos Foutzitis, Baltimore, MD (US); Javier Santoro, Victoria (CA)

(73) Assignee: ADCOR MAGnet Systems, LLC, Baltimore, MD (US)

(21) Appl. No.: 15/330,560

(22) Filed: Oct. 11, 2016

Related U.S. Application Data
(60) Provisional application No. 62/240,083, filed on Oct. 12, 2015.

(51) Int. Cl. H04B 7/06; H01Q 21/28; H01Q 1/28; B64C 39/02; B64C 1/36; B64D 47/02

(52) U.S. Cl. CPC H04B 7/0602; H01Q 21/28; H01Q 1/28; B64C 2201/00; B64C 1/36; B64D 47/02; B64D 2203/00; B64C 39/024

(57) ABSTRACT

An antenna system provides greater range than conventional omnidirectional antennas while using substantially the same or less power by a system of antenna components, arranged so as to permit in the aggregate transmission over an effective 360 degrees as an omnidirectional antenna, while permitting selection of one of the components so as to reduce the amount of energy required. One application for the invention is use on drones or other lightweight vehicles where weight and power are significant considerations, but where range is also a significant objective.

This application is entitled to, and claims the benefit of, priority from U.S. Provisional Application Ser. No. 62/240,083, filed Oct. 12, 2015, which is incorporated herein by reference.

### FIELD AND BACKGROUND OF THE INVENTION

### Field of the Invention

The present invention relates in general to antenna technology and in particular to a new and useful antenna suitable for use where power and weight are significant considerations in the design of an antenna where range is important.

### Background Information

This invention exploits the performance superiority of directional vs omni-directional antennas.

An antenna gives the wireless system two fundamental properties: gain and direction. Gain is a measure of increase in power. Gain is the amount of increase in energy that an antenna adds to a radio frequency (RF) signal. Direction is the shape of the transmission pattern. As the gain of a directional antenna increases, the angle of radiation usually decreases. This provides a greater coverage distance, but with a reduced coverage angle. The coverage area or radiation pattern is measured in degrees. These angles are measured in degrees and are called beamwidths.

An antenna is a passive device which does not offer any added power to the signal. Instead, an antenna simply redirects the energy it receives from the transmitter. The redirection of this energy has the effect of providing more energy in one direction, and less energy in all other directions.

### Omni-Directional Vs Directional Antennas

An ideal omni-directional antenna has a theoretical uniform three-dimensional radiation pattern (similar to a light bulb with no reflector). In other words, an isotropic omni-directional antenna has a perfect 360 degree vertical and horizontal beamwidth or a spherical radiation pattern. It is an ideal antenna which radiates in all directions and has a gain of 1 (0 dB), i.e. zero gain and zero loss.

### SUMMARY OF THE INVENTION

It is an object of the invention to provide an antenna system which provides greater range than conventional omnidirectional antennas while using substantially the same amount of, or less, power.

It is another object of the invention to provide an antenna system suitable for use on drones or other lightweight vehicles where weight and power are significant considerations, but where range is also a significant objective.

A principal feature of the invention is a system of antenna components, arranged so as to permit in the aggregate transmission over an effective 360 degrees as an omnidirectional antenna, while permitting selection of one of the components so as to reduce the amount of energy required.

These and other objects, features and advantages which will be apparent from the discussion which follows are achieved, in accordance with the invention, by providing an antenna system having a series of antennas, disposed evenly around a 360 degree platform and under control of a system which permits determining which of said antennas is pointed toward a receiver and selectively powering that determined antenna.

The various features of novelty which characterize the invention are pointed out with particularity in the claims annexed to and forming a part of this disclosure. For a better understanding of the invention, its advantages and objects, reference is made to the accompanying drawings and descriptive matter in which a theoretical embodiment and a working prototype of the invention is illustrated.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is an illustration of the radiation patterns of omnidirectional and directional antennas.

FIG. 2 is an illustration of gain and beamwidth of various antenna configurations.

FIG. 3 is a schematic overview of a multi-antenna system.

FIG. 4 illustrates a working prototype of the invention and a prior art omnidirectional antenna.

FIG. 5 is a schematic of the circuit board used in controlling the prototype of FIG. 4.

FIG. 6 shows the specifications of the core antenna printed circuit board.

FIG. 7 shows the printed circuit board of FIG. 6 with four antennas attached.

FIG. 8 is code suitable for controlling the antenna system of the invention.

### DESCRIPTION OF THE PREFERRED EMBODIMENT

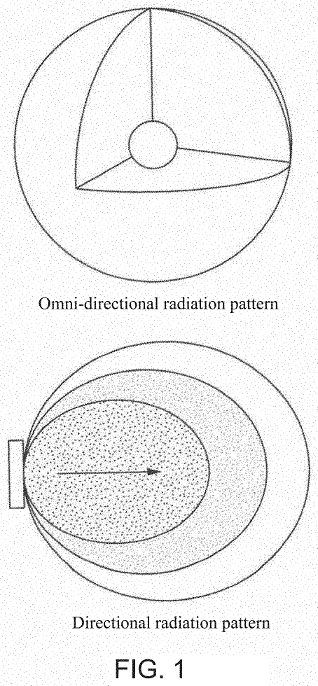

Omni-directional and Directional radiation patterns are shown in FIG. 1.

While an omni-directional antenna radiates the RF energy uniformly in all directions as per the left image above, directional antennas focus the RF energy in a particular direction. As the gain of a directional antenna increases, the coverage distance increases, but the effective coverage angle decreases. For directional antennas, the lobes are pushed in a certain direction and little energy is there on the back side of the antenna as per the right image above.

Concluding, the fundamental omnidirectional antenna advantage Vs the directional is that it covers all 360 degrees around it without dead zones. Its main disadvantage is that its gain is significantly reduced compared to a directional one and therefore the data link range achieved when omnis are employed is considerably reduced compared to directional antennas.

Drone manufacturers use only omni-directional antennas on the airborne datalink side to make sure they will cover all possible directions around the drone. Directional antennas cannot be used on such platforms since the drone has an unpredicted flight path and continuously changes headings. Therefore, if a directional antenna was to be employed, there would be no means to keep its beam locked to the direction of the drone Ground Control Station resulting in a frequently broken data link. For this reason, directional antennas cannot be used onboard drones. Since omni-directional antennas are currently the only antennas used on drones, the airborne data link has a reduced coverage range and degraded quality.

The aforementioned invention allows the use of four (4) directional antennas, each one with 90 degrees beam width. Combining the 4 beams into a single structure (array) we get a coverage similar to the omnidirectional antenna but with significantly improved gain and consequently improved range (more than double). The prototype was manufactured using four directional antennas, which proved suitable for the purposes of proving the workability of the concept. Other embodiments could, of course, be built with other configurations, for example with eight antennas each one with 45 degrees of bandwidth. Preferably, other embodiments would distribute the individual antennas equally (i.e., the same separation of each individual antenna from its nearest neighbor), and most preferably the number of antennas would be a multiple of four.

The heart of the invention is a circuit called Geospatial antenna controller (GAC). The GAC employs as main components a microprocessor unit (MCU) and microwave RF switches. The MCU receives geospatial data (attitude, position and positional relations) from an integrated inertial measurement unit (IMU), runs fast algorithms to decide which antenna to activate each time and commands the RF switches accordingly.

The outcome of this technology is that the smart antenna more than doubles the range of the drone data link. If for example, a drone can be controlled from the Ground Control Station over a range of 5

Km with an omni antenna, this range becomes 10 Km with the use of the Geospatial Smart Antenna (GCSAnt).

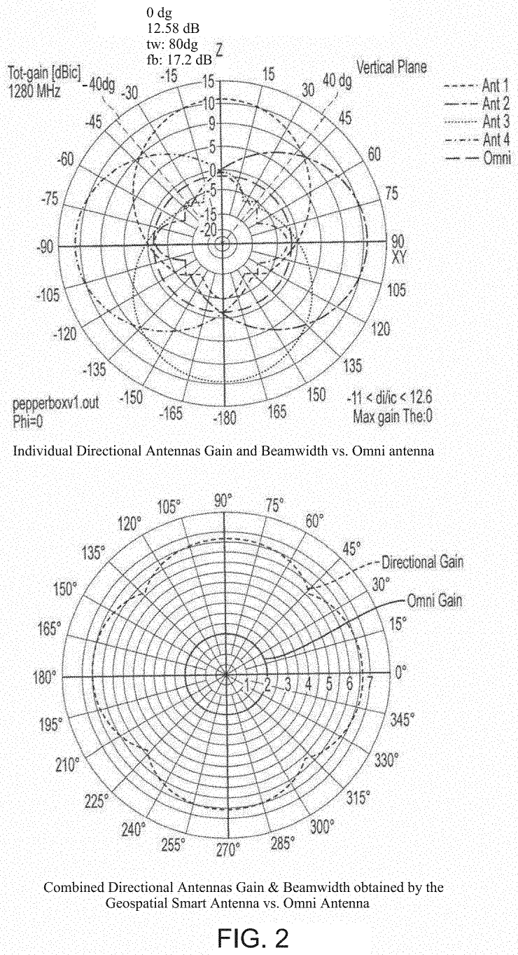

The relative beamwidths and associated gain between the array of 4 directional antennas and the single omni antenna are presented in FIG. 2. As shown in FIG. 2, the Geospatially Controlled Smart Antenna, achieves 3-4 times the gain of an Omni-directional antenna while retaining the 360 degrees coverage of the omni-beam.

This technology can be used on mobile platforms of any kind (Airborne, Land Based, Sea based) to increase their data links range and improve the quality of the data transferred. Specifically, this technique has never been used before on unmanned systems.

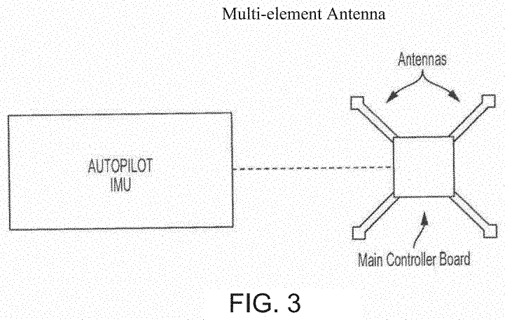

The multielement antenna is shown conceptually on FIG. 3, comprising:
1. The antenna controller board
2. The Antenna Radiating elements
3. The external Inertial Measurement Unit (IMU). This can also be a complete autopilot board that includes an IMU.

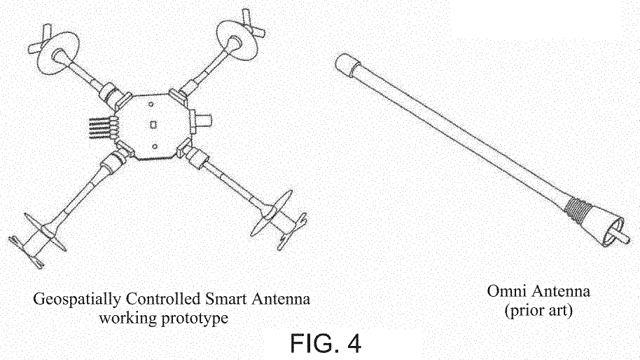

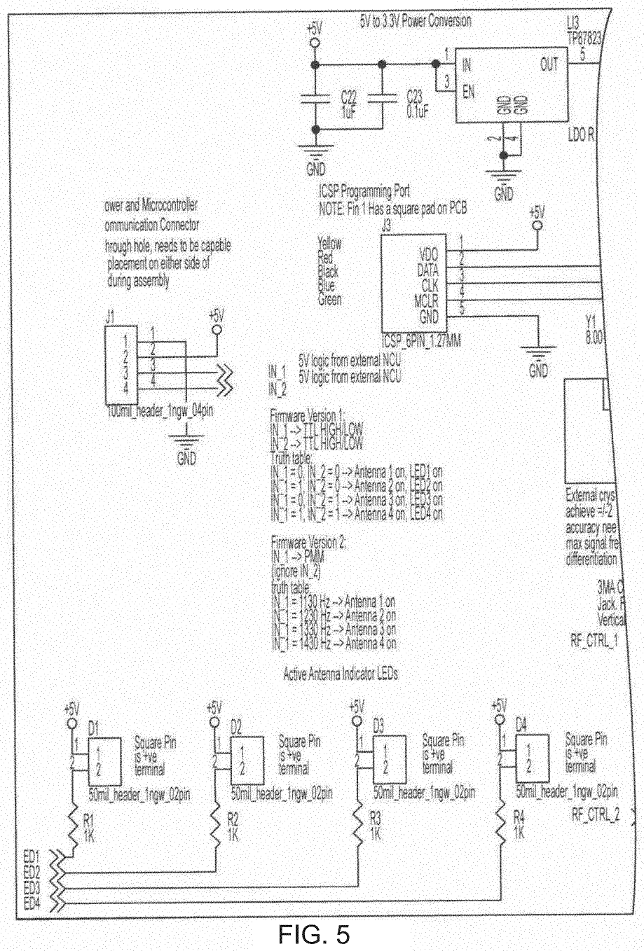

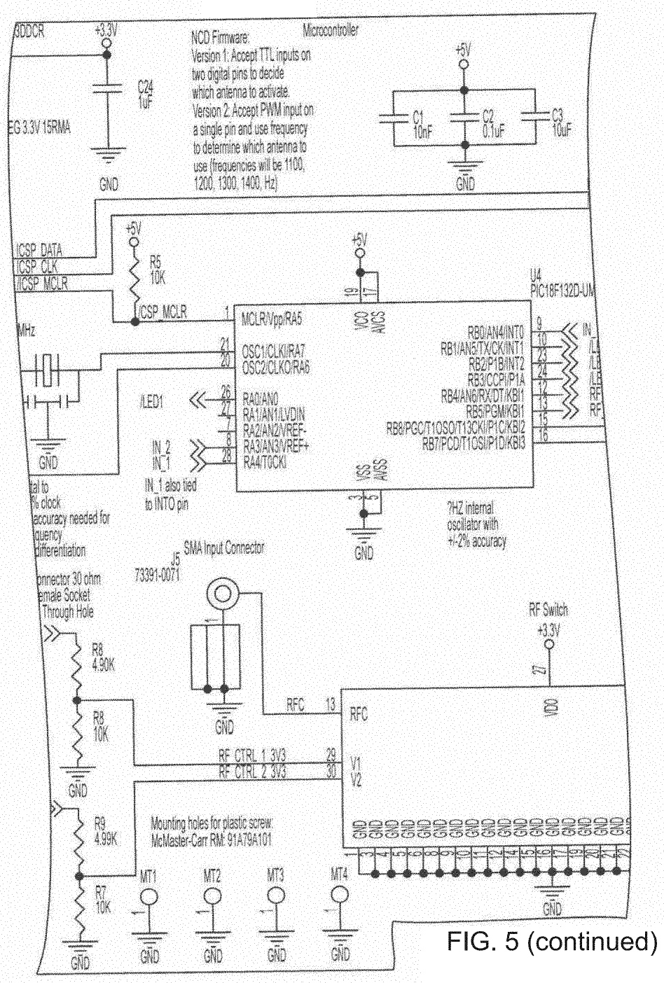

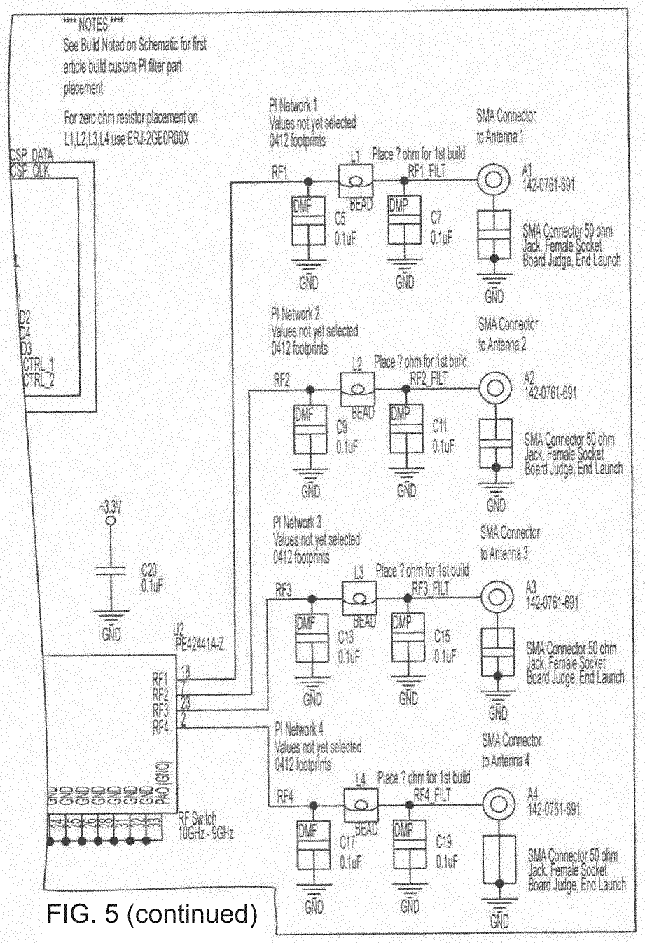

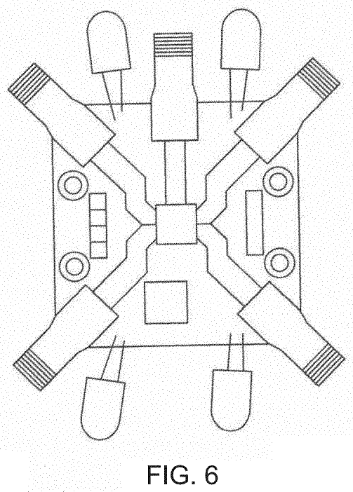

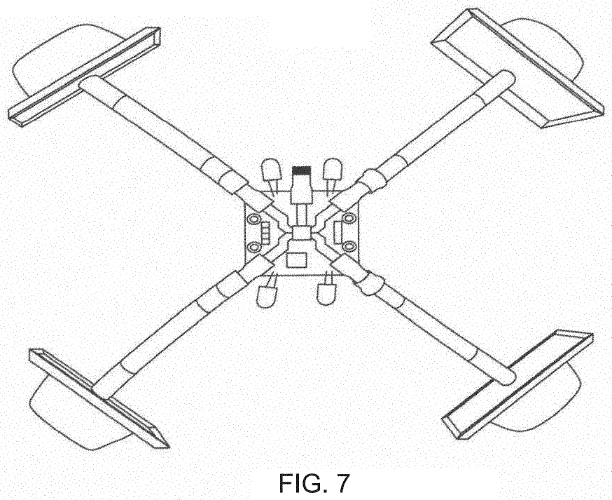

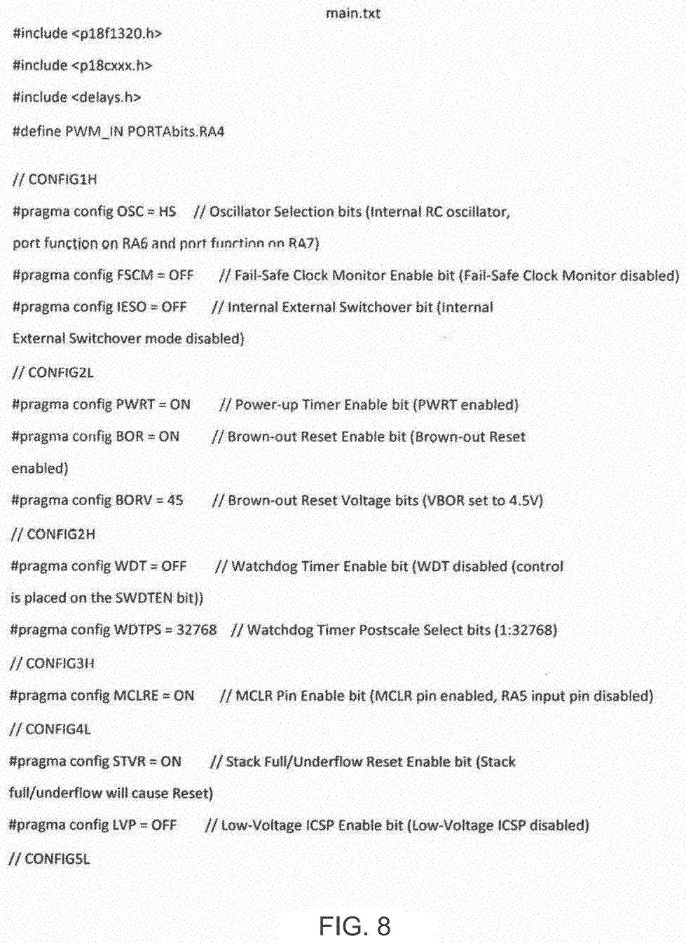

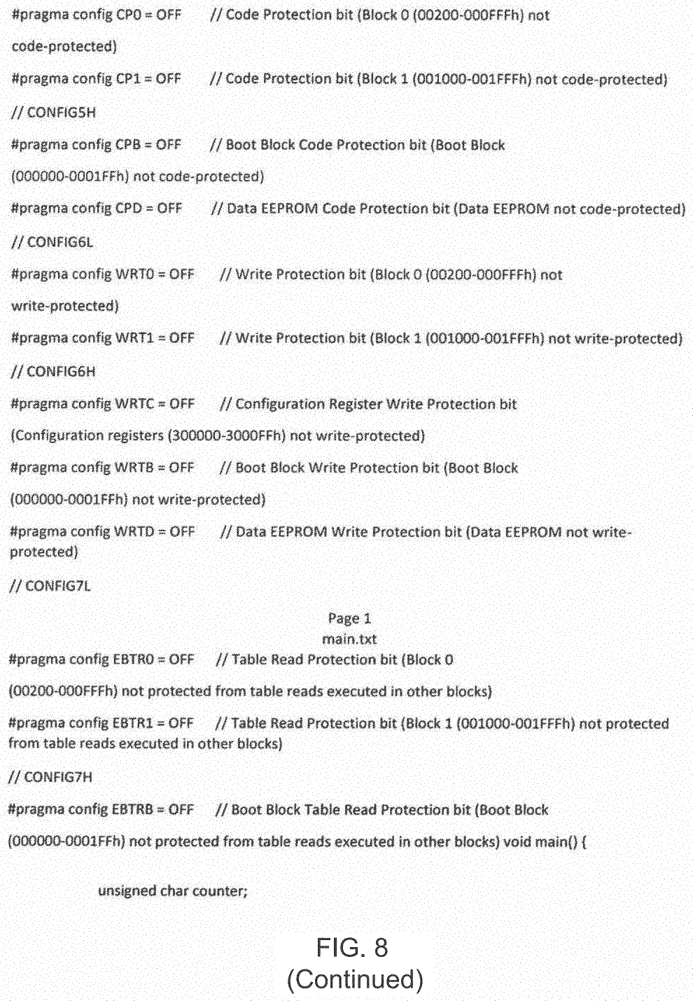

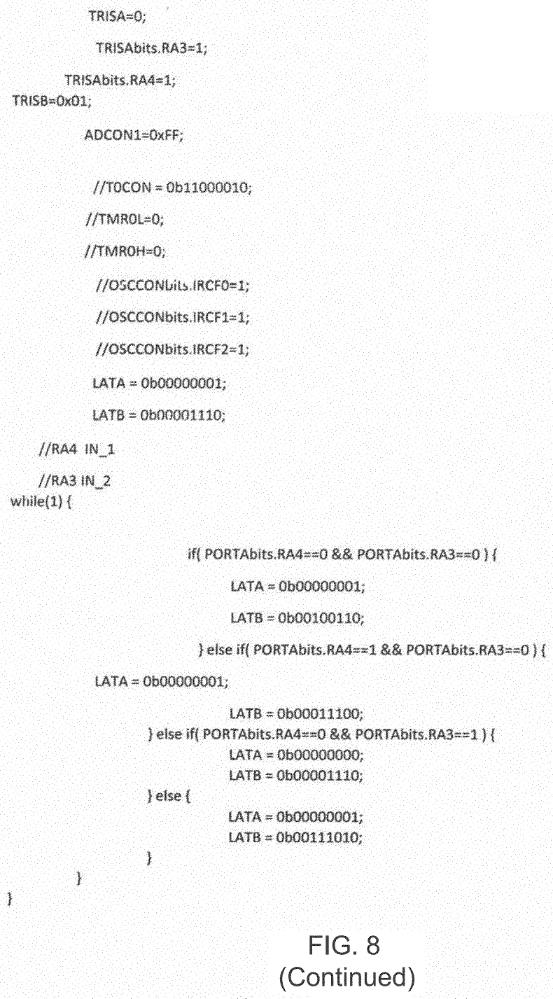

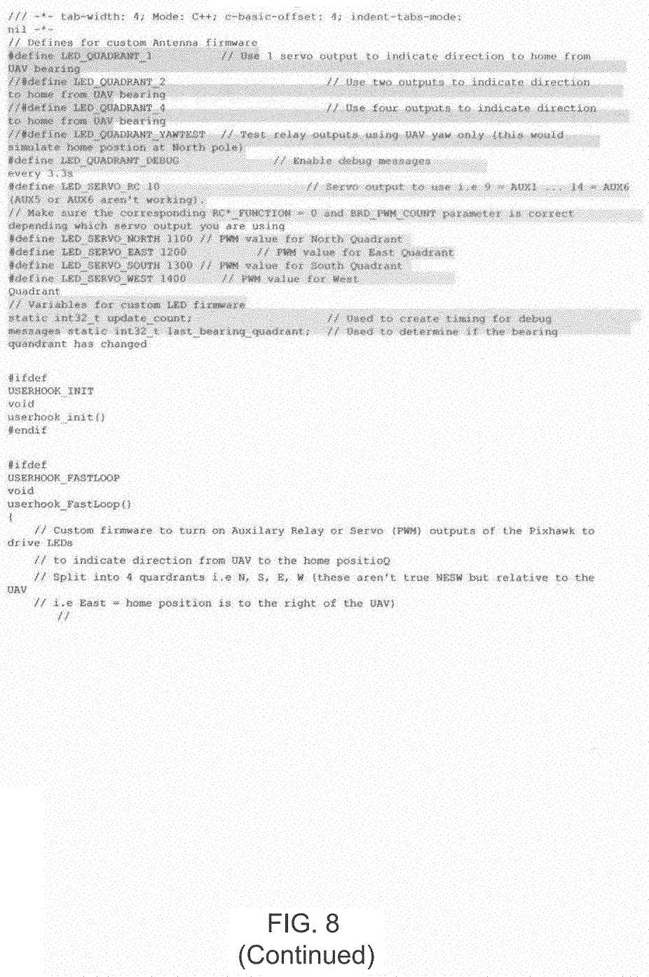

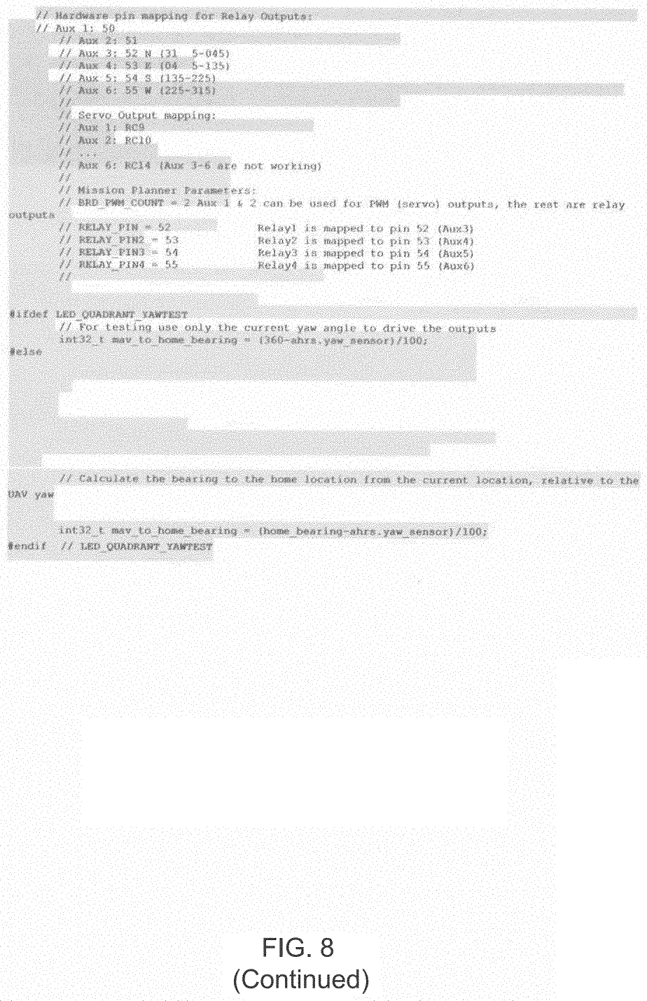

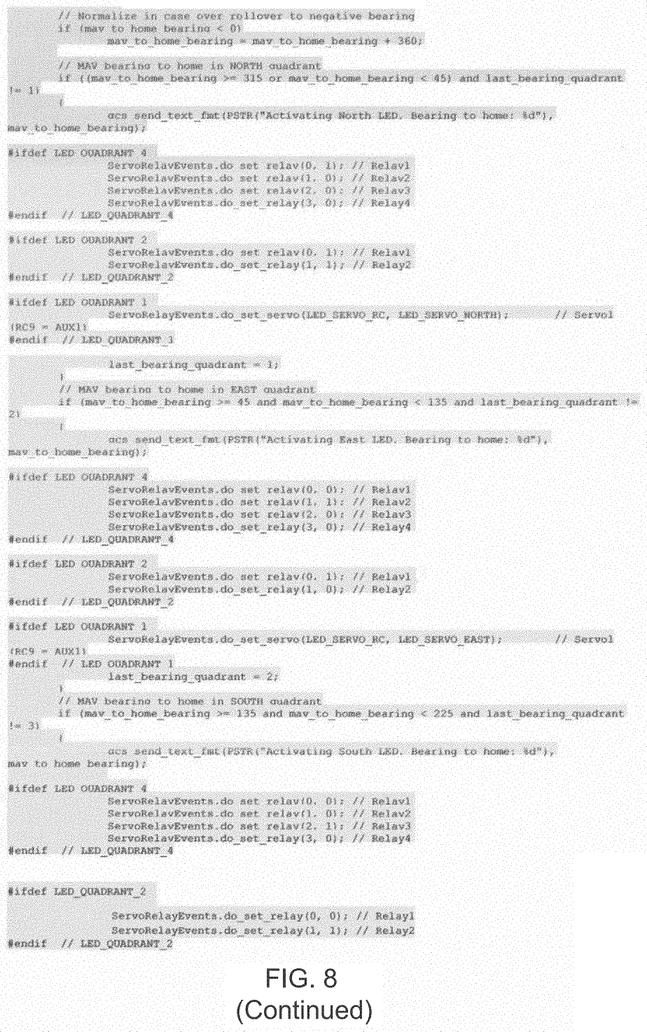

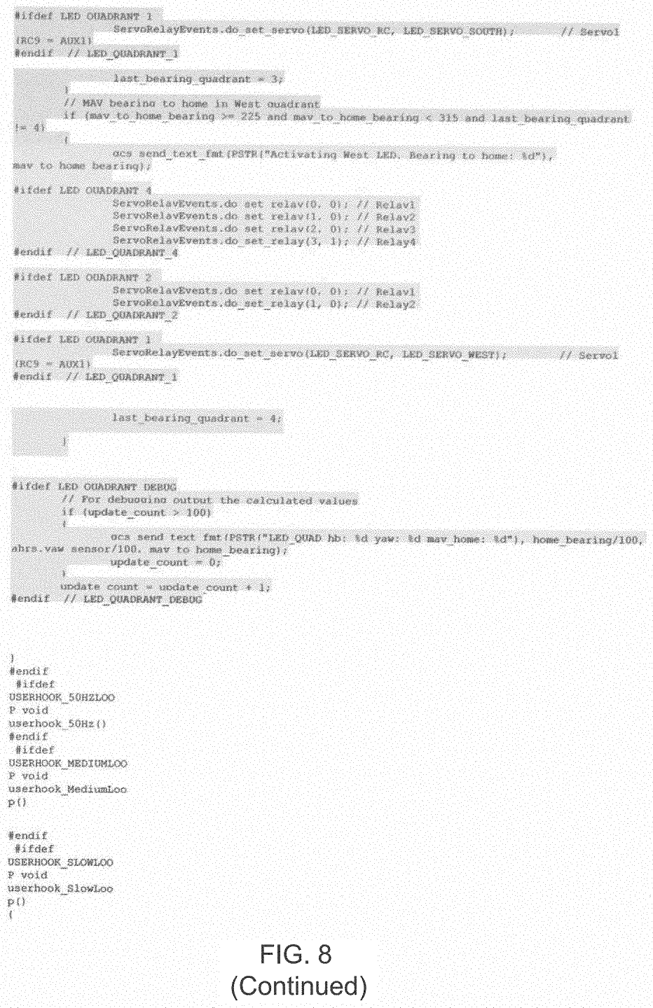

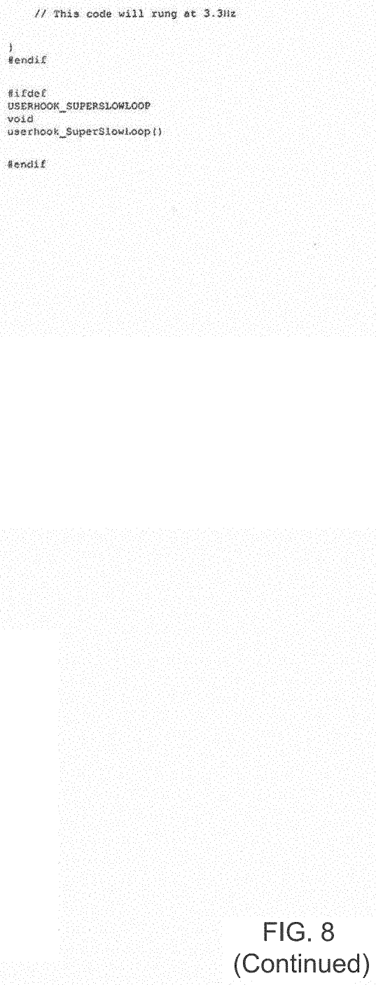

A working prototype is shown in FIG. 4, along with a prior art omni antenna. The prototype included:
a. The controller board is presented in schematic form in FIG. 5. The prototype Core Antenna printed circuit board is shown in FIG. 6. The prototype Core Antenna with external antennas attached, as used for the max-range flight, is shown in FIG. 7.
b. The firmware that runs on the controller board microprocessor unit
c. We have modified the firmware that runs on the autopilot board so it can control our antenna controller. So the code we have developed runs on the autopilot side and on the antenna controller side. Suitable code is shown in FIG. 8.

However, the autopilot is an off-the-self product that has its own firmware. This firmware is open source. As I explained above, we modified this open source firmware to work with our controller.

Also, the antenna radiating elements are off-the-self components that we buy from 3^{rd} party antenna manufacturers.

1. An antenna system having a series of antennas, disposed evenly around a 360 degree platform and under control of a system which permits determining which of said antennas is pointed toward a receiver and selectively powering that determined antenna.

2. The antenna system of claim 1 wherein the series of antennas comprises four antennas, disposed at 90 degrees to each other.

3. The antenna system of claim 1 wherein the series of antennas comprises eight antennas, disposed at 45 degrees to each other.

4. The antenna system of claim 1, further comprising:
a geospatial antenna controller coupled to the series of antennas, the geospatial antenna controller including a microprocessor programmed to:
determine a direction of the receiver;
select an antenna of the series of antennas associated with the determined direction of the receiver; and
operate the selected antenna to broadcast a signal to the receiver.

5. The antenna system of claim 4, further comprising a plurality of radio frequency (RF) switches, each RF switch coupled to a corresponding antenna, the microprocessor is programmed to determine an RF switch associated with the selected antenna and energize the associated RF switch to broadcast the signal to the receiver via the selected antenna.

6. The antenna system of claim 1, further comprising an inertial measurement unit configured to generate geospatial data associated with a drone vehicle, the microprocessor programmed to:
receive the geospatial data from the inertial measurement unit; and
determine the direction of the receiver based on the received geospatial data.

7. An antenna system comprising:
a platform;
a plurality of directional antennas coupled to the platform, each directional antenna extending radially outwardly from the platform and spaced evenly about a perimeter of the platform; and
a geospatial antenna controller coupled to the plurality of directional antennas, the geospatial antenna controller including a microprocessor programmed to:
determine a direction of a ground station receiver;
select a directional antenna of the plurality of direction antennas associated with the determined direction of the ground station receiver; and
operate the selected directional antenna to broadcast a signal to the ground station receiver.

8. The antenna system of claim 7, further comprising a plurality of RF switches, each RF switch coupled to a corresponding directional antenna, the microprocessor is programmed to determine an RF switch associated with the selected directional antenna and energize the associated RF switch to broadcast the signal to the ground station receiver via the selected directional antenna.

9. The antenna system of claim 7, wherein the platform includes a printed circuit board.

10. The antenna system of claim 7, wherein the platform is mounted to a drone vehicle.

11. The antenna system of claim 10, further comprising:
an inertial measurement unit mounted to the drone vehicle for generating geospatial data associated with the drone vehicle, the microprocessor programmed to:
receive the geospatial data from the inertial measurement unit; and
determine the direction of the ground station receiver based on the received geospatial data.

12. The antenna system of claim 7, wherein the plurality of directional antennas includes four directional antennas disposed at 90 degrees from each adjacent directional antenna.

13. The antenna system of claim 7, wherein the plurality of directional antennas includes eight directional antennas disposed at 45 degrees from each adjacent directional antenna.

14. The antenna system of claim 7, including a plurality of LED lights, each LED light associated with the a corresponding directional antenna, the microprocessor programmed to operate an LED light associated with the selected directional antenna.

15. A drone vehicle comprising:
an inertial measurement unit configured to generate geospatial data associated with the drone vehicle; and
an antenna system coupled to the inertial measurement unit, the antenna system including:
a platform;
a plurality of directional antennas coupled to the platform, each directional antenna extending radially outwardly from the platform and spaced evenly about a perimeter of the platform; and
a geospatial antenna controller coupled to the plurality of directional antennas, the geospatial antenna controller including a microprocessor programmed to:
receive geospatial data from the inertial measurement unit;
determine a direction of a ground station receiver based on the received geospatial data;
select a directional antenna of the plurality of direction antennas associated with the determined direction of the ground station receiver; and
operate the selected directional antenna to broadcast a signal to the receiver.

16. The drone vehicle of claim 15, wherein the antenna system includes a plurality of RF switches, each RF switch coupled to a corresponding directional antenna, the microprocessor programmed to determine an RF switch associated with the selected directional antenna and energize the associated RF switch to broadcast the signal to the ground station receiver via the selected directional antenna.

17. The drone vehicle of claim 15, wherein the platform includes a printed circuit board.

18. The drone vehicle of claim 15, wherein the plurality of directional antennas includes four directional antennas disposed at 90 degrees from each adjacent directional antenna.

19. The drone vehicle of claim 15, wherein the plurality of directional antennas includes eight directional antennas disposed at 45 degrees from each adjacent directional antenna.

20. The drone vehicle of claim 15, including a plurality of LED lights, each LED light associated with the a corresponding directional antenna, the microprocessor programmed to operate an LED light associated with the selected directional antenna.
